(19) United States
(12) Patent Application Publication
(10) Pub. No.: US 2020/0296990 A1
(43) Pub. Date: Sep. 24, 2020

(54) GLUTEN-ENRICHED BIODEGRADABLE GUM BASE

(71) Applicant: TEREOS STARCH & SWEETENERS BELGIUM, Aalst (BE)

(72) Inventor: Nadia CAMUEL, Marckolsheim (FR)

(21) Appl. No.: 16/089,134

(22) PCT Filed: Mar. 31, 2017
(86) PCT No.: PCT/IB2017/051854

§ 371 Date: Sep. 27, 2018

(30) Foreign Application Priority Data
Mar. 31, 2016 (BE) BE-2016/5229

(51) Int. Cl. A23G 4/08; A23G 4/10; A23G 4/20

(52) U.S. Cl. CPC A23G 4/08; A23V 2002/00; A23G 4/20; A23G 4/10

(57) ABSTRACT

A gum base comprising from 30% to 70% by weight of an elastomer, from 1% to 20% by weight of wheat gluten, from 1% to 20% by weight of plasticizer and from 5% to 25% by weight of wax, a chewing gum comprising such a gum base and a method for producing such a gum base and/or such a chewing gum.

This application claims the benefit of Belgian patent application No. BE-2016/5229, filed Mar. 31, 2016, which is hereby incorporated by reference in its entirety.

### FIELD OF THE DISCLOSURE

The present disclosure relates to a gluten-enriched gum base, to the method for producing such a gum base, to the chewing gum containing such a gum base and also to the method for producing such a chewing gum.

### BACKGROUND

The prior art describes many biodegradable chewing gums containing proteins and in particular gluten.

Nevertheless, although the chewing gums of the prior art are biodegradable and digestible, they do not have organoleptic qualities that are similar or at the very least comparable to those of a chewing gum on the market, in particular those comprising only synthetic gum base.

By way of indication, international application WO 94/17673 or international application WO 00/78158 proposes a chewing gum comprising gluten and glycerol, propylene glycol, polydextrose, calcium carbonate or rice flour in order to adjust the texture in the mouth. Nevertheless, the chewing gums described in these applications do not have a flexible and smooth texture such as that observed for a chewing gum on the market.

The prior art and in particular American patent application U.S. Pat. No. 3,814,815 likewise proposes chewing gums comprising partially denatured gluten and a high water content. However, this water content reduces the lifetime of the chewing gum obtained. In addition, the denaturation of the gluten reduces the protein elasticity characteristics.

The prior art does not therefore propose a chewing gum which has improved organoleptic characteristics while at the same time maintaining the durability and biodegradability characteristics of the chewing gum.

### SUMMARY

The invention in some embodiments therefore relates to a gum base comprising:
30% to 70% by weight of an elastomer, preferentially 40% to 60%, and more preferentially 44% to 55%,
1% to 20% by weight of wheat gluten, preferentially 2% to 15%, more preferentially 3% to 14%; typically, the wheat gluten is native or easily crosslinked,
1% to 20% by weight of plasticizer, preferentially 5% to 15%, and more preferentially 7% to 13% by weight of plasticizer; typically, the plasticizer is glycerol,
5% to 25% of wax, preferentially between 10% and 20%, more preferentially between 12% and 18%, even more preferentially from 14% to 16%, said wax preferentially having a melting point of between 50 and 90° C., more preferentially between 60 and 85° C.,
0 to 25% by weight of mineral filler, preferentially 5% to 15%, or else 7% to 13%.

According to the present invention, the term “elastomer” is intended to mean natural, synthetic and/or rubber elastomers. Typically, the term “elastomer” is intended to mean a gum base. Examples of rubber are butyl rubber and styrene-butadiene rubber. The natural elastomers are, for example, substances of plant origin, such as chicle, crown gum, nispero, rosadinha, j elutong, perillo, niger gutta, tunu, balata, gutta-percha, leche caspi, sorva, gutta kay, analogs thereof or a combination thereof. The synthetic elastomers can in particular be styrene-butadiene copolymers, polyisobutylene, isobutyleneisoprene copolymers, polyethylene, and the combination thereof, analogs thereof, or the combination of such analogs. The elastomer can also comprise a non-toxic vinyl polymer, such as polyvinyl acetate and the partial hydrolysate thereof, polyvinyl alcohol, or a combination thereof. When it is used, the molecular weight of the vinyl polymer can range from approximately 3000 Da up to and including approximately 94 000 Da. Additional useful polymers comprise: crosslinked polyvinylpyrrolidone, polymethyl methacrylate; copolymers of lactic acid, polyhydroxyalkanoates, plasticized ethylcellulose, polyvinyl acetate phthalate, or a combination thereof. The elastomer according to some embodiments of the invention can comprise solvents and in particular resins such as terpene resins and rosin esters.

The “loss factor tan delta” and also “dynamic modulus of elasticity E′” according to the invention are evaluated by the DMTA (Dynamic Mechanical Thermal Analysis) technique on a Tritec 2000 device sold by Triton Technology Ltd. The DMTA analysis is described according to the standard DIN 53513. The DMTA analysis makes it possible, through the variation in temperature of the sample, to measure the modulus of elasticity (E′) corresponding to the elastic characteristics of the gum, the loss modulus (E″) corresponding to the viscous characteristics of the gum and the loss factor tan δ providing information on the viscoelastic properties of the gum. Typically, the loss factor tan delta and also the dynamic modulus of elasticity E′ or the loss modulus (E″) are evaluated at a measurement frequency of 1 Hz and a displacement of 0.05 mm in single cantilever bending mode.

These peaks of loss tan delta, of dynamic modulus of elasticity E′ and also of loss modulus (E″) are observed at a temperature applied to the sample. Thus, the temperature at which these peaks are observed is an indicator of the hardness or of the viscoelastic qualities of the sample and therefore of its behavior as a function of its temperature, such as for example its hardness at ambient temperature or in the mouth during chewing.

The loss factor tan delta and also dynamic modulus of elasticity E′ are viscoelastic behaviors of the gum bases which are characterized by DMTA via their respective glass transition phase. This phase is characterized by an abrupt drop in the values of the modulus of elasticity, also corresponding to a drop in the loss modulus, and to a loss factor tan δ peak. The gum bases can thus be classified in three texture categories: very hard gum bases, medium hardness gum bases or low hardness gum bases.

A hardness characterized by a temperature at the loss factor tan δ peak above 45° C. corresponds to a gum base of high hardness.

A hardness characterized by a temperature at the loss factor tan δ peak below 33° C. corresponds to a low hardness and does not correspond to the market acceptability criterion.

A hardness characterized by a temperature at the loss factor tan δ peak between 33° C. and 45° C. corresponds to a medium hardness that is particularly sought on the market.

Thus, said gum base according to some embodiments of the invention has a temperature at the loss tan delta peak between 33 and 45° C. and/or a drop in dynamic modulus of elasticity E′ between −2 and −20° C.

A combination of several types of gum bases is also possible for obtaining the specific properties sought during the process of producing and/or chewing the chewing gum.

Advantageously, said elastomer comprises a blend:
of a first elastomer having a temperature at the loss factor tan delta peak above 45° C., typically between 48 and 55° C., and/or a drop in dynamic modulus of elasticity E′ above −22° C., preferentially between −15° C. and 0° C. and
of a second elastomer having a temperature at the loss factor tan delta peak above 33° C., typically between 30 and 5° C., and/or a drop in dynamic modulus of elasticity E′ below −1.2° C., preferentially between −10 and −25° C.

According to the present invention, the term “gluten” is intended to mean wheat gluten, preferentially the wheat gluten added to the blend is a vital wheat gluten.

The term “plasticizer” is a compound having plasticizing properties; the plasticizer is, for example, chosen from a polyol syrup or a hydrogenated starch hydrolysate, glycerol, lecithin, water, glyceryl monostearate, glyceryl distearate, fatty acid monoglycerides, fatty acid diglyceride, triacetin, acetylated monoglycerides, polyglycerol esters, glyceryl triacetate, carbohydrate polyesters, or a mixture thereof.

According to the present invention, the term “wax” is intended to mean a wax or a mixture of waxes. The term “wax” denotes a carbon-base non-polar linear molecular, more particularly an ester of ethylene glycol and of two fatty acids or a monoester of a fatty acid and of an alcohol comprising long chains. The wax may be of natural origin, may be derived from petroleum or may be of synthetic origin. Advantageously, the wax or the mixture of waxes comprises natural waxes such as plant wax, or mineral waxes or waxes of animal origin. Mention may for example be made, as plant wax, of candelilla wax, carnauba wax, sugarcane wax, rice bran wax, bayberry wax, sunflower wax, cocoa butter, shea butter or Japan wax. Some examples of animal waxes are beeswax, lanolin and whale wax. The petroleum-derived waxes comprise microcrystalline wax and paraffin wax. Synthetic waxes comprise polyethylene and Fischer-Tropsch wax. The mineral waxes comprise lignite, ozokerite and ceresin. The waxes comprise totally hydrogenated waxes and partially hydrogenated waxes.

The wax(es) of the wax mixtures have a melting point of between 50 and 90° C., preferentially between 60 and 85° C. Advantageously, according to some embodiments of the invention, the wax mixture comprises at least a first wax having a melting point of between 60 and 65° C. and at least a second wax having a melting point of between 80 and 85° C. Advantageously, the wax is of natural origin, preferentially included among the group of beeswaxes, of carnauba wax and a mixture thereof.

Typically, according to some embodiments of the invention, the ratio of the first wax having a melting point between 60 and 65° C. to the second wax having a melting point between 80 and 85° C. is between 15/85 and 70/30, preferentially from 20/80 to 55/45, between more preferentially 25/75 and 45/55 and even more preferentially 30/70 and 40/60.

According to some embodiments of the present invention, the gluten and the plasticizer are in a gluten/plasticizer weight ratio of between 1/3 and 2/3, the plasticizer preferentially being glycerol.

Typically, the mineral filler is in pulverulent form; mention may be made of clays and silicas. Examples of suitable fillers are carbonates, sulfates, oxides, hydroxides, phosphates and silicates of metals, such as alkaline-earth metals, in particular calcium and magnesium. In one preferred embodiment, the filler is talc, which is a magnesium silicate. In another preferred embodiment, the filler is calcium carbonate. Chalk or dicalcium phosphate are also very suitable mineral fillers. The filler can consist of a single component or, as a variant, it can comprise a mixture of two or more of the abovementioned suitable fillers.

Advantageously, when the mineral filler is talc, the gum base according to some embodiments of the invention comprises 0 to 15% by weight of talc, preferentially from 5% to 12%.

Advantageously, when the mineral filler is calcium carbonate, the gum base according to some embodiments of the invention comprises 0 to 8% by weight of CaCO₃, preferentially from 3% to 6%.

Typically, the gum base according to some embodiments of the invention can also comprise a sweetening agent.

The invention in some embodiments also relates to a method for producing a gum base, characterized in that it comprises:
a step of heating from 30% to 70% by weight of an elastomer at a temperature of between 30 and 45° C.,
a step of adding from 1% to 20% by weight of a vital wheat gluten,
a step of adding from 1% to 20% by weight of a plasticizer; typically, said plasticizer is added to the gluten before incorporation into the composition,
a step of adding from 5% to 25% by weight of at least one wax typically having a melting point of between 50 and 90° C., preferentially between 60 and 85° C., and
optionally, a step of adding from 0 to 25% of mineral fillers, preferentially from 0.1% to 25%.

Typically, the mixture is prepared in a mixer such as, for example, of the Winkworth Z-blender type. Preferentially, the mixer comprises a jacket maintained at a temperature below 45° C., for example at 35° C. The rotation speed of the mixer is advantageously 40 revolutions per minute (rpm).

The ingredients are added according to the following protocol:
1) preheating-mixing of the elastomers, typically for 1 minute;
2) addition of the plasticizer, preferentially glycerol, and addition of the gluten, the mixture is preferentially stirred for 2 minutes;
3) addition of the mineral filler such as talc and/or calcium carbonate, the mixture is preferentially stirred for 2 minutes;
4) addition of the waxes, typically beeswax and/or carnauba wax, the mixture is preferentially stirred for 5 minutes.

The invention in some embodiment also relates to a chewing gum comprising:
20% to 40% by weight of the gum base according to an embodiment of the invention,
2% to 15% by weight of a plasticizer, preferentially 3% to 12%, typically a syrup and in particular a polyol syrup, for example a maltitol syrup,
20% to 60% by weight of a sweetening agent, such as pulverulent sorbitol or pulverulent maltitol or a mixture of pulverulent polyols,
0.5% to 10% by weight of flavoring, in liquid and pulverulent or encapsulated form,
0 to 0.5% of at least one intense sweetener, typically chosen from sucralose, potassium acesulfame, aspartame, and a mixture thereof,
0 and 1% by weight of a dye (for example titanium dioxide),
optionally from 0.5% to 10% by weight of a flavoring, said chewing gum having a water content of less than 5% preferentially of between 0 and 2.5%.

The term “chewing gum” is intended to mean a composition comprising a part which is insoluble in water or saliva consisting of the gum base and a soluble part comprising in particular a sweetening agent, a plasticizer, an additive and/or a flavoring. More particularly, the term “chewing gum” is intended to mean a composition comprising a gum base, a sweetening agent, at least one plasticizer, and at least one flavoring.

Various chewing gum formulas and also the method for producing same are widely described in the literature and in particular in “Formulation and Production of Chewing and Bubble Gum” by Fritz, Douglas p. 142. In general, chewing gums are obtained by sequential addition of the various ingredients of the chewing gum (˜15-20 minutes) in a market blender well known to those skilled in the art, for example a jacketed blender which allows fine control of the temperature so as to allow softening of the gum base and regulation of the temperature of the chewing gum mass, for example at 50° C., during the method for obtaining the chewing gum.

The term “sweetening agent” is intended to mean a sweetener such as D-glucose, saccharose, polyols or a mixture thereof. The polyol(s) (or sugar alcohol(s)) is(are) preferentially chosen from sorbitol, maltitol, erythritol, isomalt, xylitol, mannitol and a mixture thereof advantageously, a mixture of polyols such as sorbitol and xylitol, sorbitol and maltitol, or sorbitol and mannitol. The polyol is advantageously sorbitol alone or in combination with maltitol and/or xylitol. The sweetening agent is typically in a pulverulent form. The sweetening agents also include polydextrose; raftilose; raftiline; fructooligosaccharides (for example: NutraFlora®); palatinose; guar gum hydrolysates (for example: Sun Fiber®); and/or indigestible dextrins (for example: Fibersol®, Nutriose®). The sweetening agent may also comprise a sweetener such as an intense sweetener in particular chosen from stevia extract (rebaudioside), aspartame, potassium acesulfame, thaumatine, saccharin, cyclamate, sucralose or a mixture thereof. Typically, the preferred intense sweeteners are aspartame, sucralose and potassium acesulfame.

Preferentially, the chewing gum is sugar-free.

The term “flavoring” is intended to mean natural or artificial flavoring agents. The flavorings or flavoring agents can comprise essential oils, natural extracts, synthetic flavorings or mixtures thereof, including, but without being limited thereto, oils derived from plants and from fruits, such as citrus oils, fruit essences, peppermint essence, green mint essence, other mint oils, essence of clove, wintergreen oil, aniseed, and the like. When the flavoring used is artificial, it can for example be a sensory component which gives a tingling sensation or a thermal sensation during chewing, such as a cooling or heating effect. Such components comprise cyclic and acyclic carboxylic acid amides, menthol and menthol derivatives, such as menthyl esters of acids that are acceptable as a food additive, and capsaicin, inter alia. Acidulants can be included in order to give an acidulous taste and to reinforce the perception of fruity flavorings.

The flavorings or flavoring agents can be used in amounts of approximately 0.1% by weight to approximately 15% by weight of chewing gum, and preferably from approximately 0.2% by weight to approximately 5% by weight. Typically, the flavorings or flavoring agents are in liquid and/or pulverulent form.

Typically, in some embodiments the chewing gum according to the invention has a plasticizer content of from 3% to 15% by weight of a plasticizer, typically the chewing gum comprises a mixture of plasticizers. Among the known plasticizers, the preferred plasticizers are chosen from glycerol, propylene glycol, polyol syrups, lecithin and a mixture thereof.

Advantageously, the chewing gum comprises from 3% to 15% by weight of syrup and in particular of polyol syrup, for example a maltitol syrup containing 70% and 85% of solids and comprising 50% to 60% of maltitol by weight of solids, or a sorbitol syrup containing 65% and 75% of solids and comprising 70% and 85% of sorbitol by weight of solids. A particularly advantageous example of maltitol syrup is the Maltilite®5580 syrup sold by the applicant. Typically, the chewing gum also comprises between 0.01% and 2% by weight of lecithin, preferentially between 0.1% and 1.5%, even more preferentially between 0.2% and 1%. Advantageously, the chewing gum also comprises from 0.2% to 10% by weight of glycerol, preferentially from 0.5% to 8%, more preferentially 1% to 6%, even more preferentially from 2% to 5%. Advantageously, said chewing gum has a gluten/plasticizer, and more particularly gluten/glycerol, weight ratio of between 25/75 and 55/45.

Advantageously, the chewing gum also has 0 to 10% of mineral filler, more particularly 0 to 7% of talc and/or 0 to 5% of CaCO₃.

Typically, the chewing gum according to some embodiments of the invention has a sweet-coating layer.

The invention in some embodiments also relates to a method for obtaining a chewing gum, characterized in that it comprises:
a step of providing a gum base according to an embodiment of the invention or implementing a method for obtaining a gum base according to an embodiment of the invention,
a step of mixing from 20% to 40% by weight of said gum base with 3% to 15% by weight of a plasticizer, typically of a syrup, from 20% to 60% by weight of a sweetening agent, from 0 to 0.5% of at least one intense sweetener and, optionally, from 0.5% to 15%, preferentially from 0.5% to 10%, by weight of a flavoring and/or from 0 and 1% by weight of a dye.

Typically, the mixing step is carried out at a temperature between 30 and 45° C.

It will be noted that, in the conventional methods for producing the chewing gum of the prior art, the mixing step is carried out at temperatures exceeding 45° C. Such temperatures leading to a denaturation of the gluten have the effect of reducing the elasticity of the gum base of some embodiments of the invention.

Optionally, said method can comprise a sweet-coating step, where appropriate preceded by a gumming step.

The invention in some embodiments also relates to the chewing gum directly produced by implementing this method.

Although they have distinct meanings, the terms “comprising”, “containing” and “consisting of” have been used interchangeably in the description of the invention, and can be replaced with one another.

Other features, aspects, subjects and advantages of the present invention will emerge more clearly on reading the description and the examples which follow.

### BRIEF DESCRIPTION OF THE FIGURES

FIG. 1: Evaluation by DMTA of the rheological characteristics of a Dreyco® gum base.

FIG. 2: Comparison of the temperatures of the peaks of the modulus of elasticity E′ and of the loss factor Tan δ of the gum bases.

### DETAILED DESCRIPTION OF EMBODIMENTS

### Examples

### Example 1 Establishment of Recipes for Chewing Gums Comprising Gluten

Various chewing gum recipes were developed in order to reduce a portion of the synthetic gum of the chewing gum with vital wheat gluten so as to increase the percentage of biodegradable product in the chewing gum compositions (see table 1).

TABLE 1
Gum base recipes in which a portion of the
synthetic gum has been replaced with gluten

| | Recipe A′ | Recipe B′ | Recipe C′ | Recipe D′ |
|---|---|---|---|---|
| | (% by | (% by | (% by | (% by |
| Ingredients | weight) | weight | weight | weight |
| Synthetic gum base | 61.73 | 58.13 | 47.14 | 50.65 |
| Vital wheat gluten | 3.23 | 5.87 | 14.06 | 11.23 |
| (AMYGLUTEN ®) | | | | |
| Glycerol | 1.62 | 2.93 | 7.03 | 5.74 |
| Beeswax | 5.392 | 5.33 | 4.95 | 5.22 |
| (Stearinerie Dubois) | | | | |
| Carnauba wax | 10.782 | 10.67 | 10.42 | 10.44 |
| (NATUROCHIM) | | | | |
| Talc | 12.13 | 12 | 11.46 | 11.75 |
| Calcium carbonate | 5.12 | 5.07 | 4.95 | 4.96 |

The complete recipes are set out in table 2. The ingredients in bold represent the gum base recipe, the other ingredients being those of the chewing gum.

In order to develop a recipe for a chewing gum having sensory characteristics closer to the chewing gums on the market, the synthetic gum bases used are those described in example 2

TABLE 2
Chewing gum recipes in which a portion of the
synthetic gum has been replaced with gluten

| | Recipe A | Recipe B | Recipe C | Recipe D |
|---|---|---|---|---|
| | (% by | (% by | (% by | (% by |
| Ingredients | weight) | weight | weight | weight |
| Synthetic gum base | 22.9 | 21.8 | 18.1 | 19.4 |
| Vital wheat gluten | 1.2 | 2.2 | 5.4 | 4.3 |
| (AMYGLUTEN ®) | | | | |
| Glycerol | 0.6 | 1.1 | 2.7 | 2.2 |
| Beeswax (Stearinerie | 2 | 2 | 1.9 | 2 |
| Dubois) | | | | |
| Carnauba wax | 4 | 4 | 4 | 4 |
| (Naturochim) | | | | |
| Talc | 4.5 | 4.5 | 4.4 | 4.5 |
| Calcium carbonate | 1.9 | 1.9 | 1.9 | 1.9 |
| Pulverulent sorbitol | 42.6 | 42.4 | 41.7 | 41.9 |
| MERISORB ®200 | | | | |
| Pulverulent maltitol | 6.4 | 6.4 | 6.3 | 6.3 |
| MALTILITE ®P200 | | | | |
| Maltitol syrup | 5.6 | 5.5 | 5.5 | 5.5 |
| MALTILITE ®5580 | | | | |
| Glycerol | 2.4 | 2.4 | 2.3 | 2.3 |
| Soybean lecithin | 0.9 | 0.9 | 0.9 | 0.9 |
| Sucralose | 0.05 | 0.05 | 0.05 | 0.05 |
| Acesulfame K | 0.1 | 0.1 | 0.1 | 0.1 |
| Powdered flavoring | 2.4 | 2.4 | 2.3 | 2.3 |
| Liquid flavoring | 2.4 | 2.4 | 2.3 | 2.3 |
| Titanium dioxide | 0.1 | 0.1 | 0.1 | 0.1 |

Tests on the Degree of Gluten Incorporation

Gluten is a protein which has very advantageous viscoelastic properties. However, its viscoelasticity is lower compared with the elastomers commonly used in the formulation of the gum bases on the market. Consequently, this may result in a chewing gum texture that is significantly softer after a few seconds of chewing or even deliquescent, depending on the level of incorporation. Thus, above 20% by weight of gluten in the gum base, the inventors observed a deliquescence of the gum base obtained after 1 to 3 minutes of chewing, which did not make it possible to validate this mixture.

When the degree of gluten incorporation into the gum base is between 0% and 10%, the sensory tests showed that a degree of incorporation of less than or equal to 4.3% allows the production of a chewing gum that is comparable to the products normally sold, whereas a high degree produces a chewing gum which is still entirely presentable and consumable, but is however not quite as close to the usual products in terms of texture.

Tests on the Amount of Glycerol, Glycerol/Gluten Ratio

The inventors noted that the amount of glycerol to be added to the mixture and in particular the gluten/glycerol ratio is important in order to obtain a homogeneous mass that can be easily mixed with the other components and that makes it possible to produce a chewing gum under good conditions.

The ratio of glycerol in the gum base also allows hydration of the gluten and the acquisition of a flexible structure.

Such hydration gives the gum base a smooth structure in the mouth which is not observed by adding water.

After numerous tests, the inventors noted that the mixture temperature reduced below 45° C. makes it possible to preserve the elastic properties of the mass. This involves decreasing the temperature of the jacket of the blender. The inventors showed that a temperature of 35° C. instead of 50° C. in the context of a conventional method for producing chewing gum was particularly advantageous. In addition, a temperature of more than 30° C. applied during the mixing makes it possible to improve the mixing of the materials and provides the desired elasticity properties in the gluten.

Tests on the Choice of Waxes or Fats and the Amount of Wax

The inventors showed that a final texture comparable to that of a chewing gum on the market cannot be obtained without the addition of wax. More particularly, the inventors demonstrated that an amount of less than 5% of wax in the gum base is insufficient to give a texture comparable to that of a chewing gum on the market. In addition, the tests showed that above 25% of wax, a significant increase in the firmness of the chewing gum obtained is noted, as is a decrease in its elasticity. Furthermore, during the implementation of the method, such compositions show a brittle texture which hampers the steps of laminating and cutting up the chewing gum. Natural waxes were preferred. The waxes provide the formula with better cohesion together and thus reduce the risk of disintegration. These waxes are selected with a very high melting point in order to also compensate for the loss of firmness linked to the introduction of gluten. The various waxes or fats with a high melting point that are used have the following melting points:
candelilla wax 70° C.,
carnauba wax 85° C.
rice bran wax (E908) 78° C.
beeswax 65° C.
glyceryl dibehenate 70° C.
stearine TP1200 69.6° C.

Tests were carried out on various waxes. The first tests show that the presence of wax clearly improves the texture of the gum base compared with the absence of wax. Nevertheless, some gum bases stand out through their much improved characteristics. Only the best gum bases were used for the production of chewing gums and were evaluated by sensory analysis.

The sensory evaluation of the chewing gums was the subject of a strict protocol implemented by a panel specifically trained for tasting chewing gums. The chewing gum tasting protocol is documented, it is more particularly described in “Formulation and production of chewing and bubble gum” by Douglas Fritz (Kennedys Books Ltd)—Hardcover (2008). This protocol is organized in 3 phases.

The initial phase corresponds to the bite in the mouth for the first 10 seconds of tasting; the intermediate phase up to 3 minutes describes precisely the sensory properties of the chewing gum in terms of hydration, texture and aromatic perception since it is during this period that most of the flavorings and sweeteners are extracted from the matrix. The final phase beyond 3 minutes characterizes the degree of stability of the chewing gum properties over time, in terms mainly of consistency and aromatic perception.

The organoleptic parameters were evaluated by a trained panel made up of 9 individuals.

TABLE 3

| Wax | Processability | Sensory tests |
|---|---|---|
| Candelilla wax | Non-tacky | Not tested since mixture |
| | Gluey | not sufficiently homogeneous |
| | Non-flexible, dry, | |
| | non-homogeneous | |
| | structure of | |
| | the mixture obtained, | |
| | loss of elasticity | |
| Rice bran wax | Flexible but no elasticity | Not tested since mixture |
| (E908) | Non-homogeneous | not sufficiently homogeneous |
| | mixture | |
| Carnauba was | Mixture relatively | Feeling of non-homogeneity |
| flakes | homogeneous | in the mouth |
| | | Very dry on bite and crunchy |
| Pulverulent | Relatively | Good bite, does not |
| carnauba wax | flexible and | disintegrate in the mouth |
| | elastic mixture | Slight shrinking in the mouth |
| 1% | Behavior during mixing | Texture close to a gluten- |
| carnauba wax | close to that of a standard | free CG |
| 2% beeswax | gluten-free CG | Does not disintegrate |
| | | Maintains firmness until the |
| | | end of tasting |
| Sprayed | Relative elasticity and | Good firmness on bite |
| glyceryl | dryness | Rapid disintegration |
| dibehenate | | |
| Powdered | Dry on cutting up | Good firmness on bite |
| stearine | Breaks easily | Sticks to the teeth and then |
| TP1200 | | disintegrates |

During the initial phase (first 10 seconds) the bite hardness, the cohesion, the speed of perception and the aromatic intensity are evaluated. During the intermediate phase (10 seconds to 3 minutes) the hydration (time taken by the matrix to absorb saliva), the cohesion, the texture (smooth to granular), the tackiness on the teeth, the aromatic intensity, the sweetness and the refreshing power are evaluated. Finally, during the final phase (3 to 6 minutes) the hardness, the texture, the tackiness on the teeth, the size of the chewing gum in the mouth, the form in the mouth (between two chews), the consistency and the width of the line when the chewing gum is drawn are evaluated. The evaluation system uses a 5-point system corresponding to five grades or scores for each of the descriptors. All of the parameters defined above were tested (initial phase, intermediate phase and final phase). The scores and all of the parameters tested are described in table 3 above.

At the end of these tests, it is noted that the addition of beeswax, used alone, gives the final chewing gum flexibility and binding. However, the chewing gum softens and then rapidly disintegrates in the mouth.

The addition of carnauba wax, used alone, gives the final chewing gum firmness and thus makes it possible to prevent disintegration. However, the size of the chewing gum in the mouth rapidly shrinks.

The combination of beeswax and carnauba wax makes it possible to improve the processability and the sensory properties by providing the correct firmness in the mouth and by preventing disintegration during chewing.

A carnauba wax/beeswax ratio of 33/66 makes it possible to produce a chewing gum with a suitable texture, which is neither too soft nor too firm, improved with respect to the use of one or other alone, even if the chewing gum does not yet have a texture identical to that of a conventional gluten-free chewing gum. A carnauba wax/beeswax ratio of 66/33 makes it possible to obtain the mechanical properties sought in terms of DMTA analyses with a temperature at the peak of the loss factor tan delta of between 33 and 45° C. The carnauba wax/beeswax ratio of 66/33 provides a processability close to that of a conventional chewing gum in terms of flexibility, tackiness and homogeneity in the mixer, and also appropriate sensory properties by providing flexibility and firmness throughout chewing while at the same time maintaining a smooth texture in the mouth.

Talc and Calcium Carbonate

The inventors noted that calcium carbonate is more effective than talc in terms of providing firmness. However, calcium carbonate gives a final product with sensory properties that are less pleasant in the mouth. The tests made it possible to show that the combination of calcium carbonate and talc conferred better characteristics than one or other of these products separately.

Nevertheless, an amount of greater than 2% for calcium carbonate results in the production of a chewing gum that is too powdery/gritty in the mouth, and 7% of talc, also induces a mass that is too dry, making the lamination step very difficult.

### Example 2: Selection of the Gum Bases

Hardness Characteristics of the Gum Base

A large number of gum bases on the market were used as a mixture with gluten in order to determine the gum(s) allowing partial replacement with gluten.

Various gum bases were analyzed alone or in the compositions of some embodiments of the invention in order to better characterize and compare these gum bases with those of some embodiments of the invention.

The gum bases tested are the Dreyco®, Geminis® and Excel® gums from the producer Cafosa.

The elasticity of the gum bases used was analyzed by the DMTA technique (Dynamic Mechanical Thermal Analysis, Tritec 2000 equipment sold by Triton Technology Ltd). More particularly, the DMTA equipment is used in single cantilever bending mode. The sample is placed between two attachment jaws and undergoes mechanical sinusoidal vibration stresses allowing the mechanical properties of the sample to be measured.

The gum base samples are prepared according to the following dimensions: width of between 12 and 12.7 mm, thickness of between 3.2 and 4.5 mm, distance between the jaws of between 5.0 and 5.5 mm.

Each series of tests is carried out according to an identical protocol: temperature increase from −100° C. to +100° C., according to a temperature gradient of 2° C. per minute, a displacement of 0.05 mm and a frequency of 1 Hz. These parameters require cooling reinforced by means of liquid nitrogen, so as to cover the temperature range beginning at −100° C.

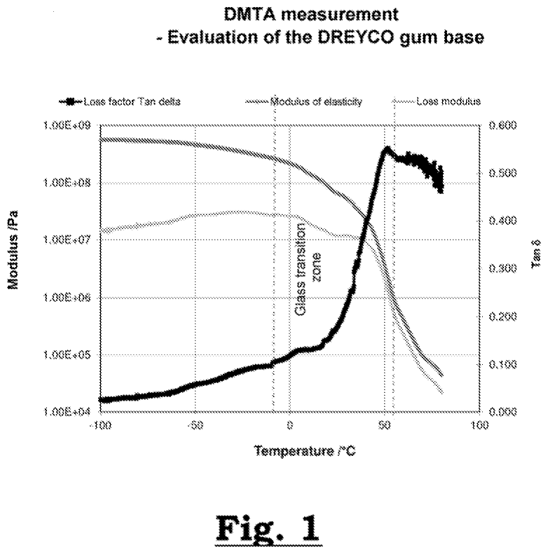

This technique allows an evaluation of the rheological characteristics of the gum base in particular (FIG. 1)
the modulus of elasticity (E′) corresponding to the elastic characteristics of the gum,
the loss modulus (E″) corresponding to the viscous characteristics of the gum,
the loss factor tan δ providing information on the viscoelastic properties of the gum.

The glass transition phase is a characteristic which determines the texture of the gum and consequently of the final chewing gum. This glass transition phase is characterized by an abrupt drop in the values of the modulus of elasticity, also corresponding to a drop in the loss modulus, and to a peak of the loss factor tan δ.

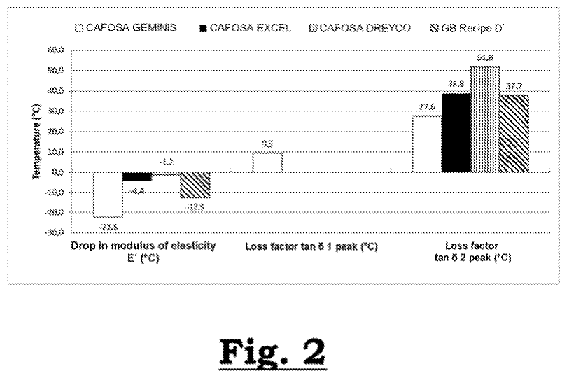

The analysis is repeated in an identical manner on several synthetic gum bases on the market and also on the gum base of an embodiment of the invention. The results obtained are indicated on the graph in FIG. 2. The important values are also compiled in summarizing form in the graph (FIG. 2).

Three groups are clearly identifiable by comparison in particular of the modulus of elasticity E′ and of the loss factor Tan δ. The principle of the measurement by DMTA is to subject the gum base material to a mechanical stress, under the influence of an increasing temperature gradient. Dynamic mechanical analysis subjects the sample to an oscillating force and measures the amplitude of the displacement resulting therefrom.

A hard gum will be characterized by a late drop in the modulus of elasticity, that is to say corresponding to a higher temperature, and also a peak of the loss factor Tan δ appearing at a higher temperature.

The results show that the Dreyco® gum from the Cafosa producer has very high hardness characteristics with a drop in E′ at −1.2° C. and a Tan δ peak at 51.8° C.

Conversely, the Geminis® gum from the Cafosa producer has a very low hardness which is characterized by a modulus of elasticity E′ which declines first with an inflection point at −22.5° C. and two Tan δ peaks at 9.5° C. and at 27.6° C.

These gum bases were tested alone or as a mixture in the gum base recipes of table 1 and in the chewing gum recipes of table 2.

Sensory tests showed that the Dreyco® and Geminis® gums from the Cafosa producer were not the best for obtaining a chewing gum comprising gluten with good characteristics.

The tests showed that the Geminis® soft gum base gives the chewing gum obtained a soft and deliquescent texture, which creates a chewing gum that is not very chewable.

The use of a Dreyco® very hard gum base makes it possible to strengthen the hardness at bite. However, the elasticity properties during prolonged chewing remain too weak. The chewing gum thus obtained therefore has a texture that is too hard and not elastic enough, compared with the products on the market.

The combination of a very hard gum base with another gum base of low hardness makes it possible to optimize the texture profile, with a sufficiently firm bite hardness combined with good chewability. Thus, a mixture of 50% of Geminis® gum base (low hardness) and 50% of Dreyco® gum base (high hardness) was tested in recipe D′ of example 1 and showed the best results. The characteristics of this gum base according to an embodiment of the invention, and in particular in the form of the recipe D′, were measured by DMTA.

The analysis of the profile observed in DMTA shows that the Excel® gums from the Cafosa producer and also the gum of recipe D′ have, respectively, intermediate hardness characteristics with a drop in E′ at −4.4° C. and −12.5° C. and a Tan δ peak at 38.8° C. and 37.7° C. The gum of recipe D′ according to an embodiment of the invention is therefore comparable in terms of mechanical properties to a gum of intermediate hardness most commonly used in the chewing gum industry. It will make it possible to give the chewing gum the desired sensory properties during chewing, in terms of hardness of bite and throughout the chewing of the chewing gum.

Recipe D′ also enables better processing of the gum, in particular during the step of cutting the chewing gums into dragées or into sticks, which is greatly facilitated and entirely comparable to that of a conventional chewing gum.

### Example 3

In order to improve the chewing gum recipe comprising gluten, tests were carried out in order to determine potential effects of texturing agents or of emulsifiers on the durability or the hardness of the composition obtained.

Texturing Agent Tests

Various texturing agents were evaluated in order to determine their effects on the hardness and the durability of the gluten chewing gums obtained, compared with the conventional chewing gums.

None of the texturing agents conventionally used showed any effect on the stability of the chewing gum composition. Some showed positive effects either on the processability of the composition or in terms of the sensory characteristics of the chewing gum obtained, but none showed a notable advantage. Some showed negative effects with regard to the sensory characteristics of the product obtained.

In order to improve the texture of the chewing gum obtained, the addition of maltodextrins was tested as a replacement for a portion of the sorbitol syrup. This did not make it possible to improve the texture of the chewing gum obtained.

TABLE 4

| Texturing | | |
|---|---|---|
| agents | Processability | Sensory tests |
| Guar gum | Very dry mixture | No notable effect compared |
| | Mixing problems | with the chewing gum without |
| | after addition | guar gum |
| | of the flavoring | |
| | in powder form | |
| | Problem cutting the | |
| | gum into tabs | |
| Xanthan | Improvement in | Firmed bite |
| | the flexibility of | Limitation of the shrinking |
| | the paste. | of the gum during the test |
| | Problem with | |
| | cutting into tabs | |
| Gelatin | Improvement in | Presence of unpleasant |
| 250 bloom | the flexibility | crunchy particles |
| | of the paste | |
| | Improvement in | |
| | the conditions for | |
| | cutting into tabs | |
| Gum Arabic | Improvement in | Chewing gum drier and less |
| | the flexibility of | cohesive |
| | the paste | |
| | Very easy to | |
| | cut into tabs | |
| (Acacia + | Comparable to | Rapid deliquescence of the |
| xanthan) | xanthan | chewing gum during the test |
| Thixogum S | alone | |

Lecithin Content

Tests with various lecithin contents were carried out. The analysis of the results obtained made it possible to show that a lecithin content of between 0.2% and 1% made it possible to observe an improvement in flexibility of the gum and in its processability. The chewing gums thus obtained showed a more cohesive final texture, closer to a conventional chewing gum.

### Example 4

### Setting Up of the Method for Producing the Chewing Gum Comprising Gluten

In order improve the characteristics of the chewing gum according to some embodiments of the invention, the method for obtaining the latter was evaluated in order to adapt the conventional methods used for the chewing gums with a synthetic gum base to the chewing gums comprising gluten.

The gum base is obtained by mixing the components present in the table below in a double Z-blender (Sigma) with a jacket temperature at 35° C. and a rotation speed of 40 rpm.

With regard to the jacket temperature, the inventors noted that a high temperature reduced the viscoelastic properties of the gluten. Thus, a mixture temperature below 45° C. is preferred. The inventors showed that the optimal temperature of the iacket of the blender was 35° C.

TABLE 5

| Step | Mixing time |
|---|---|
| Mixing of the gums until a homogeneous mass is | 0′-1′00 |
| obtained | |
| Addition of glycerol and of the gluten | 1′00-3′00 |
| Addition of the talc and of the calcium carbonate | 3′00-5′00 |
| Addition of the waxes | 5′00-10′00 |
| Pulverulent sorbitol MERISORB ®200 1/3 + | 10′00-13′00 |
| (maltitol syrup: MALTILITE ® 5580 + TiO₂ | |
| dispersed) | |
| Pulverulent sorbitol MERISORB ®200 2/9 | 13′00-14′00 |
| MALTILITE ® P200 maltitol | 14′00-15′00 |
| Glycerol + soybean lecithin | 15′00-16′30 |
| Pulverulent sorbitol MERISORB ®200 (2/9) + | 16′30-18′00 |
| sweeteners (sucralose + Ace K) | |
| Liquid flavoring | 18′00-19′00 |
| MERISORB ®200 pulverulent sorbitol (2/9) | 19′00-20′00 |
| Xylitol | 20′00-21′00 |
| Powdered flavoring | 21′00-23′00 |

The method set up by the inventors made it possible to produce a chewing gum having improved gustative qualities.

The production method was developed so as to be as close as possible to a conventional chewing gum method formulated using synthetic gum base. The equipment required is therefore strictly the same (Winkworth Z-blender) as is the method of incorporating the ingredients. Only the jacket temperature must be lowered. Thus, the recipe of some embodiments of the invention is adaptable to the production lines of the current chewing gums on the market.

Sweet-Coating

A gumming step was provided for some of the chewing gum tabs. This step is carried out using a gum Arabic solution. This step is known to those skilled in the art in the production of conventional chewing gum.

The results showed that only the tabs having previously undergone a gumming step showed good stability. Thus, the gumming step makes it possible to prevent the migration of the fatty substances and, in the case in point, of the waxes from the core to the sweet-coated layer. Such gumming is very common in the chewing gum industry so as to preserve a stable dragé, without apparent marks up until the end of the shelf life of the products.

### Example 5 Characteristics of the Chewing Gum

Water Content & Water Activity

The chewing gums with a gluten content of 4.3% are obtained according to recipe D of table 2. The water content of the chewing gums according to some embodiments of the invention was evaluated. Equivalent Aw values were observed between the chewing gums according to some embodiments of the invention and the chewing gums based solely on a synthetic resin. This is an indication that the chewing gum according to some embodiments of the invention has an identical stability to the chewing gums on the market.

TABLE 6

| Recipe | aw |
|---|---|
| Chewing gum with 100% synthetic gum base | 0.40 |
| Chewing gum according to the invention according | 0.38 |
| to recipe D | |

### Example 6 Degradability

### Test for Disintegration in Water:

The degradability tests were carried out on the chewing gums obtained according to recipe D.

The degradability tests were carried out after chewing of a non-sweet-coated chewing gum tab for one minute, then deposition of the chewing gum in a beaker containing demineralized water. The whole mixture is stirred for 16 h.

The water is then filtered, then the elements retained on the filter are dried and then weighed, after 16 h in the water with stirring.

The degradability is evaluated by the loss of weight of the chewing gum before chewing and after drying, in the table below.

The test is reproduced twice with different testers.

### Results

TABLE 7

| | CG 100% synthetic gum base | CG according to recipe D |
|---|---|---|
| | (initial weight/final weight) | (initial weight/final weight) |
| Test 1 | 73% | 40% |
| Test 2 | 71% | 44% |

The results clearly show an improvement of 55% to 62% in the degradability of the CG according to embodiments of the invention compared with the chewing gums of which the gum base is solely synthetic.

1. A gum base comprising
30% to 70% by weight of an elastomer,
1% to 20% by weight of wheat gluten,
1% to 20% by weight of plasticizer,
5% to 25% by weight of wax, and
0 to 25% by weight of mineral filler.

2. The gum base as claimed in claim 1, characterized in that the plasticizer is glycerol and in that the gluten/glycerol weight ratio is between 1/3 and 2/3.

3. The gum base as claimed in claim 1, characterized in that said wax is a mixture of waxes comprising at least a first wax having a melting point of between 60 and 65° C. and at least a second wax having a melting point of between 80 and 85° C.

4. The gum base as claimed in claim 1, characterized in that it has a temperature at the loss factor tan delta peak of between 33 and 45° C. and a drop in dynamic modulus of elasticity E between −2 and −20° C.

5. The gum base as claimed in claim 1, characterized in that it comprises a mixture
of an elastomer having a temperature at the loss factor tan delta peak above 45° C. and/or a drop in dynamic modulus of elasticity E above −22° C., and
of an elastomer having a temperature at the loss factor tan delta peak below 33° C. and/or a drop in dynamic modulus of elasticity E below −1.2° C.

6. The gum base as claimed in claim 1, characterized in that said wax is of natural origin.

7. A chewing gum comprising:
20% to 40% by weight of a gum base as claimed in claim 1,
2% to 15% by weight of a plasticizer,
20% to 60% by weight of a sweetening agent,
0 to 0.5% of at least one intense sweetener,
0 and 1% by weight of a dye,
0.5% to 15% by weight of a flavoring,
said chewing gum having a water content of less than 5%.

8. The chewing gum as claimed in claim 7, characterized in that it has a sweet-coating layer.

9. A method for producing a gum base, characterized in that it comprises:
a step of heating from 30% to 70% by weight of an elastomer at a temperature of between 30 and 45° C.,
a step of adding from 1% to 20% by weight of a vital wheat gluten,
a step of adding from 1% to 20% by weight of a plasticizer;
a step of adding from 5% to 25% by weight of at least one wax typically having a melting point between 50 and 90° C., and
a step of adding from 0 to 25% of mineral fillers.

10. A method for obtaining a chewing gum, characterized in that it comprises:
a step of providing a gum base, comprising 30% to 70% by weight of an elastomer, 1% to 20% by weight of wheat gluten, 1% to 20% by weight of plasticizer, 5% to 25% by weight of wax, and 0 to 25% by weight of mineral filler, or implementing a method for producing a gum base as claimed in claim 9,
a step of mixing from 20% to 40% by weight of said gum base with 3% to 15% by weight of a plasticizer, 20% to 60% by weight of a sweetening agent, 0 to 0.5% of at least one intense sweetener.

11. The gum base as claimed in claim 1, characterized in that the wax has a melting point of between 50 and 90° C.

12. The gum base as claimed in claim 6, characterized in that said wax comprises a plant or mineral wax and/or wax of animal origin.

13. The gum base as claimed in claim 6, characterized in that said wax candelilla wax, carnauba wax, sugarcane wax, rice bran wax, bayberry wax, sunflower wax, cocoa butter, shea butter, Japan wax, beeswax, lanolin and/or whale wax.

14. The chewing gum as claimed in claim 7, characterized in that

15. The gum base as claimed in claim 1, characterized in that said at least one intense sweetener is chosen from sucralose, potassium acesulfame, aspartame, and a mixture thereof.

16. The method for producing a chewing gum according to claim 10, wherein the mixing step further comprises mixing 0.5% to 15% by weight of a flavoring and/or 0 to 1% by weight of a dye.

17. The method for producing a chewing gum according to claim 10, further comprising a sweet-coating step.

18. The method for producing a chewing gum according to claim 10, further comprising a gumming step preceding the sweet-coating step.
